(19) United States
(12) Patent Application Publication
(10) Pub. No.: US 2020/0063270 A1
(43) Pub. Date: Feb. 27, 2020

(54) BIOCIDAL-FUNCTIONALIZED CORROSION INHIBITORS

(71) Applicant: International Business Machines Corporation, Armonk, NY (US)

(72) Inventors: BRANDON M. KOBILKA, TUCSON, AZ (US); JASON T. WERTZ, PLEASANT VALLEY, NY (US); JOSEPH KUCZYNSKI, NORTH PORT, FL (US); JACOB T. PORTER, HIGHLAND, NY (US)

(21) Appl. No.: 16/106,387

(22) Filed: Aug. 21, 2018

(51) Int. Cl. C23F 11/14; C08F 8/30; A01N 43/647

(52) U.S. Cl. CPC C23F 11/149; C08F 299/024; A01N 43/647; C08F 8/30

(57) ABSTRACT

In one aspect, the disclosure is directed to a biocidal-functionalized corrosion inhibitor. The biocidal-functionalized corrosion inhibitor includes a biocidal group linked to a corrosion inhibitor group. The corrosion inhibitor group includes a triazole ring for copper (Cu) corrosion inhibition. In another aspect, the disclosure is directed to a process of forming a biocidal-functionalized corrosion inhibiting small molecule. In yet another aspect, the disclosure is directed to a process of forming a biocidal-functionalized corrosion inhibiting polymeric material.

### BACKGROUND

Recycling water cooling loops typically contain heat sinks, heat exchangers, piping/tubing, and/or other copper-based hardware. To prevent corrosion of the copper-based hardware, corrosion inhibitors are added to the cooling water, the most common and most effective of which are based on benzotriazole (BTA). In a non-hermetic water cooling loop, biofilm growth is inevitable and leads to decreased performance as the biofilm accumulates on heat sinks and heat exchangers, restricting flow. To overcome this problem, biocides are added to the cooling water to control the growth of planktonic bacteria. In some cases, the corrosion inhibitor may serve as a food source for the bacteria, spurring the accumulation of sessile bacteria and subsequent biofilm growth. Consequently, the addition of BTA to copper-based cooling loops to prevent corrosion may result in degraded performance over time.

### SUMMARY

According to an embodiment, a biocidal-functionalized corrosion inhibitor is disclosed that includes a biocidal group linked to a corrosion inhibitor group. The corrosion inhibitor group includes a triazole ring for copper (Cu) corrosion inhibition.

According to another embodiment, a process of forming a biocidal-functionalized corrosion inhibiting small molecule is disclosed. The process includes providing a biocidal compound that includes a first reactive functional group. The process also includes providing a functionalized triazole compound that includes a second reactive functional group and a corrosion inhibitor group having a triazole ring for copper (Cu) corrosion inhibition. The process further includes chemically reacting the first reactive functional group with the second reactive functional group to form a biocidal-functionalized corrosion inhibiting small molecule.

According to yet another embodiment, a process of forming a biocidal-functionalized corrosion inhibiting polymeric material is disclosed. The process includes forming a monomer mixture that includes an antimicrobial monomer having a first reactive functional group. The process also includes initiating a polymerization reaction to form a first polymeric material from the monomer mixture. The process also includes providing a substituted triazole compound that includes a second reactive functional group and a corrosion inhibitor group having a triazole ring for copper (Cu) corrosion inhibition. The process further includes forming a biocidal-functionalized corrosion inhibiting polymeric material from the first polymeric material and the substituted triazole compound.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates that the biocidal-functionalized corrosion inhibitors of the present disclosure include a biocidal group linked to a corrosion inhibitor group that includes a triazole ring for copper (Cu) corrosion inhibition.

FIG. 2 illustrates various examples of reactive functional groups that may form substituted triazole compounds to be utilized to form the biocidal-functionalized corrosion inhibitors of the present disclosure.

FIG. 3 is a chemical reaction diagram illustrating an example process of forming a biocidal-functionalized corrosion inhibiting small molecule having a direct linkage between a biocidal group and a corrosion inhibitor group, according to one embodiment.

FIG. 4 is a chemical reaction diagram illustrating an example process of forming a biocidal-functionalized corrosion inhibiting small molecule having a linking group between a biocidal group and a corrosion inhibitor group, according to one embodiment.

FIG. 5 is a chemical reaction diagram illustrating an example process of forming a biocidal-functionalized corrosion inhibiting polymeric material in which a corrosion inhibitor group forms a terminal end-group, according to one embodiment.

FIG. 6 is a chemical reaction diagram illustrating an example process of forming a biocidal-functionalized corrosion inhibiting block co-polymer having a first block that includes a biocidal group and a second block that includes a corrosion inhibitor group, according to one embodiment.

FIG. 7 is a flow diagram illustrating a particular embodiment of a process of forming a biocidal-functionalized corrosion inhibiting small molecule.

FIG. 8 is a flow diagram illustrating a particular embodiment of a process of forming a biocidal-functionalized corrosion inhibiting polymeric material in which a corrosion inhibitor group forms a terminal end-group.

FIG. 9 is a flow diagram illustrating a particular embodiment of a process of forming a biocidal-functionalized corrosion inhibiting block co-polymer having a first block that includes a biocidal group and a second block that includes a corrosion inhibitor group.

### DETAILED DESCRIPTION

The present disclosure describes biocidal-functionalized corrosion inhibitors and processes for forming biocidal-functionalized corrosion inhibitors. The biocidal-functionalized corrosion inhibitors represent a single material that is an effective corrosion inhibitor that also functions as a biocide to simultaneously prevent copper corrosion as well as biofilm growth. While the present disclosure describes various examples of antibacterial agents, it will be appreciated that the scope of the invention also encompasses fungicides.

Starting with a corrosion inhibitor, a biocidal molecule is attached either directly to the corrosion inhibitor or through a degradable linker functional group. Each embodiment serves two purposes. The direct linkage of the corrosion inhibitor with the biocide allows the biocidal activity to occur at critical locations where the corrosion inhibitor has bonded. The degradable linker (e.g., a hydrolysable ester linkage) allows the corrosion inhibitor to attach to the point where corrosion inhibition is required while allowing the biocide to detach itself and react at a given time with free floating bacteria. For the degradable linker groups, these may be monomers, oligomers, polymers, and block copolymers/oligomers.

In some embodiments, the biocidal-functionalized corrosion inhibitors of the present disclosure correspond to biocidal-functionalized corrosion inhibiting small molecules. The biocidal-functionalized corrosion inhibiting small molecules may have a direct linkage between a biocidal group and a corrosion inhibitor group. Alternatively, the biocidal-functionalized corrosion inhibiting small molecules may have a linking group between the biocidal group and the corrosion inhibitor group.

In other embodiments, the biocidal-functionalized corrosion inhibitors of the present disclosure correspond to biocidal-functionalized corrosion inhibiting polymeric (or oligomeric) materials. A corrosion inhibitor group may form a terminal end-group of the biocidal-functionalized corrosion inhibiting polymeric material. Alternatively, the biocidal-functionalized corrosion inhibiting polymeric material may correspond to a biocidal-functionalized corrosion inhibiting block co-polymer having a first block that includes a biocidal group and a second block that includes a corrosion inhibitor group.

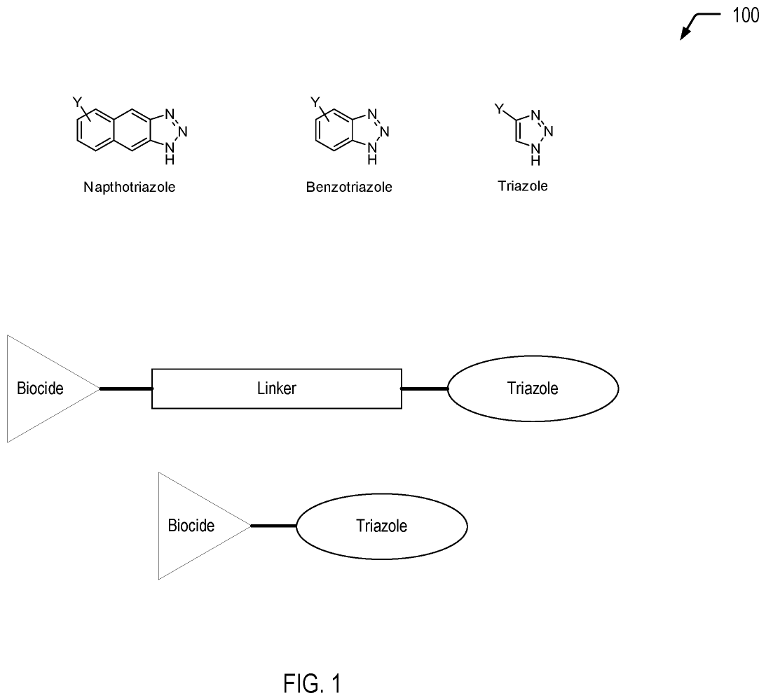

Referring to FIG. 1, a diagram 100 illustrates that the biocidal-functionalized corrosion inhibitors of the present disclosure include a biocidal group linked to a corrosion inhibitor group that includes a triazole ring for copper (Cu) corrosion inhibition. The top portion of FIG. 1 depicts three illustrative, non-limiting examples of triazole compounds that are functionalized with a reactive functional group (represented by the letter Y) for formation of various biocidal-functionalized corrosion inhibitors, including corrosion-inhibiting small molecules, oligomers, and polymers. The bottom portion of FIG. 1 illustrates that, in some embodiments, a biocide may be directly bonded to a triazole, while in other embodiments a “linker” may utilized to form a single material that includes both the biocide and the triazole.

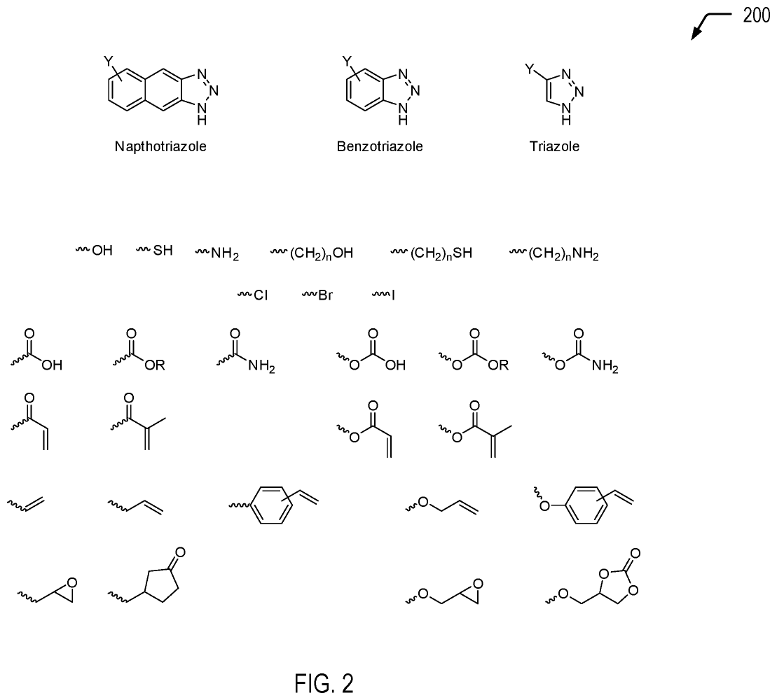

FIG. 1 depicts three examples of triazole compounds, illustrating that the corrosion inhibitor group may be a 1,2,3-Triazole or a 1,2,3-Triazole derivative. A first example, depicted on the right side of FIG. 1, is a 1,2,3-triazole compound that is functionalized with a reactive functional group, such as a 4-substituted 1H-1,2,3-Triazole with the reactive functional group at the 4-substitution position represented by the letter Y. Illustrative, non-limiting examples of reactive functional groups for the 1,2,3-triazole compound are depicted in FIG. 2.

In the middle of FIG. 1, a first example of a 1,2,3-Triazole derivative is a 1H-1,2,3-Benzotriazole (BtaH) compound that is functionalized with a reactive functional group represented by the letter Y. Illustrative, non-limiting examples of reactive functional groups for the BtaH compound are depicted in FIG. 2. A substitution position for the benzotriazole compound may vary, depending on the particular reactive functional group that is appropriate for the reactive functional group of a selected biocidal compound. In some embodiments, the functionalized benzotriazole compound may be a 5-substituted BtaH compound or a 4-substituted BtaH compound. Examples of 5-substituted BtaH compounds include: benzotriazole-5-carbonyl chloride; 5-bromo-benzotriazole; 5-chlorobenzotriazole; 5-amino-1H-benzotriazole; and benzotriazole-5-carboxylic acid. Examples of 4-substituted BtaH compounds include: 4-chlorobenzotriazole; 4-hydroxybenzotriazole; and benzotriazole-4-carboxylic acid.

The left side of FIG. 1 illustrates a second example of a 1,2,3-Triazole derivative corresponding to a naphthothiazole compound that is functionalized with a reactive functional group represented by the letter Y. Illustrative, non-limiting examples of reactive functional groups for the naphthothiazole compound are depicted in FIG. 2. A substitution position for the naphthothiazole compound may vary, depending on the particular reactive functional group that is appropriate for the reactive functional group of a selected biocidal compound.

The present disclosure contemplates the use of various antimicrobial agents that inhibit various microbial species by various antimicrobial mechanisms.

The following antimicrobial compound (or a derivative thereof) represents an example of a biocidal compound where the antimicrobial mechanism is slow release of 4-amino-N-(5-methyl-3-isoxazoyl)benzenesulfonamide, having the structural formula:

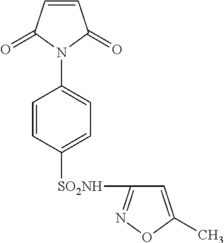

The following antimicrobial compounds (or derivatives thereof) represent examples of biocidal compounds where the antimicrobial mechanism is a tin moiety interacting with a cell wall, having the structural formulae:

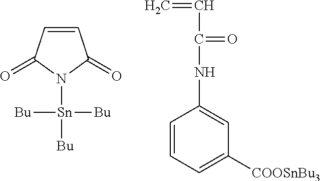

The following antimicrobial compound (or derivatives thereof) represents an example of a biocidal compound where the antimicrobial mechanism is the presence of benzimidazole derivatives inhibiting cytochrome P-450 monooxygenase, having the structural formula:

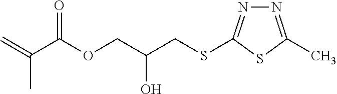 [SMILES: C=C(C)C(=O)OCC(O)CSc1nnc(C)s1]

The following antimicrobial compound (or derivatives thereof) represents an example of a biocidal compound where the antimicrobial mechanism release of norfloxacin which inhibits bacterial DNA gyrase and cell growth, having the structural formula:

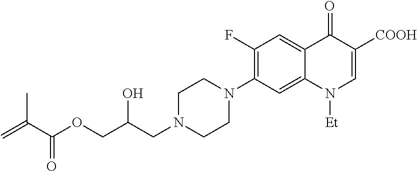 [SMILES: C=C(C)C(=O)OCC(O)CN1CCN(c2cc3c(cc2F)c(=O)c(C(=O)O)cn3CC)CC1]

The following antimicrobial compound (or derivatives thereof, such as Triclosan) represents an example of a biocidal compound where the active agent is 2,4,4′-trichloro-2′-hydroxydiphenyl-ether, having the structural formula:

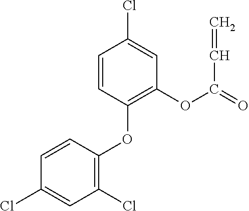 [SMILES: C=CC(=O)Oc1cc(Cl)ccc1Oc1ccc(Cl)cc1Cl]

The following antimicrobial compounds (or derivatives thereof) represent examples of biocidal compounds utilized for the bacteria S. aureus and P. aeruginosa, having the structural formula:

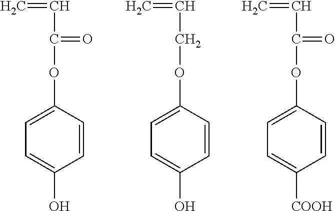

The following antimicrobial compound (or derivatives thereof) represents an example of a biocidal compound where the antimicrobial mechanism is direct transfer of oxidative halogen to the cell wall of the organism, having the structural formula:

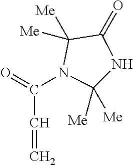

The following antimicrobial compound (or derivatives thereof) represents an example of a biocidal compound where the antimicrobial mechanism is release of 8-hydroxyquinoline moieties, having the structural formula:

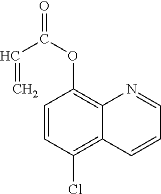 [SMILES: C=CC(=O)Oc1ccc(Cl)c2cccnc12]

The following antimicrobial compound (or derivatives thereof) represents an example of a biocidal compound where the active agent is sulfonium salt, having the structural formula:

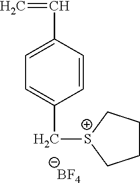

The following antimicrobial compound (or derivatives thereof) represents an example of a biocidal compound where the antimicrobial mechanism is immobilization of high concentrations of chlorine to enable rapid biocidal activities and the liberation of very low amounts of corrosive free chlorine into water, having the structural formula:

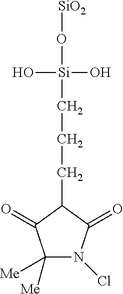

Referring to FIG. 2, a diagram 200 illustrates various examples of reactive functional groups that may form substituted triazole compounds to be utilized to form the biocidal-functionalized corrosion inhibitors of the present disclosure.

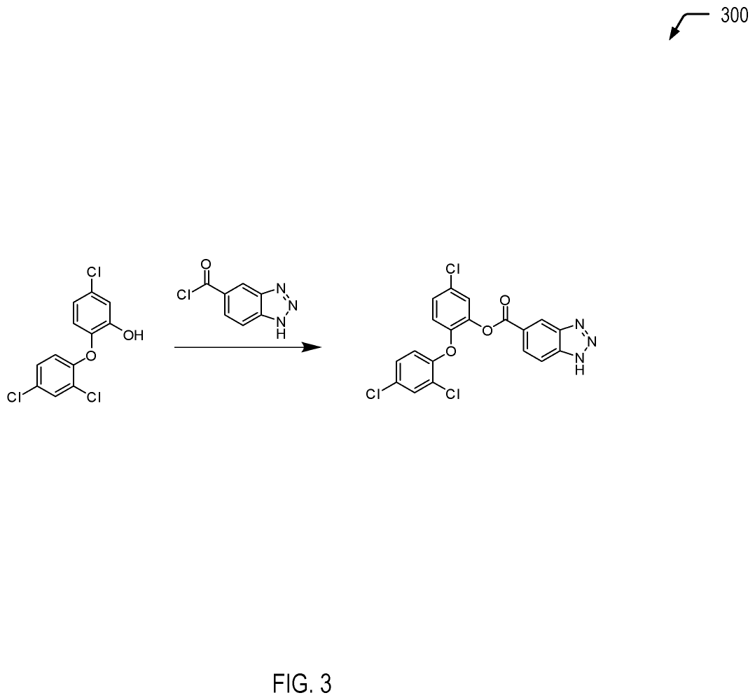

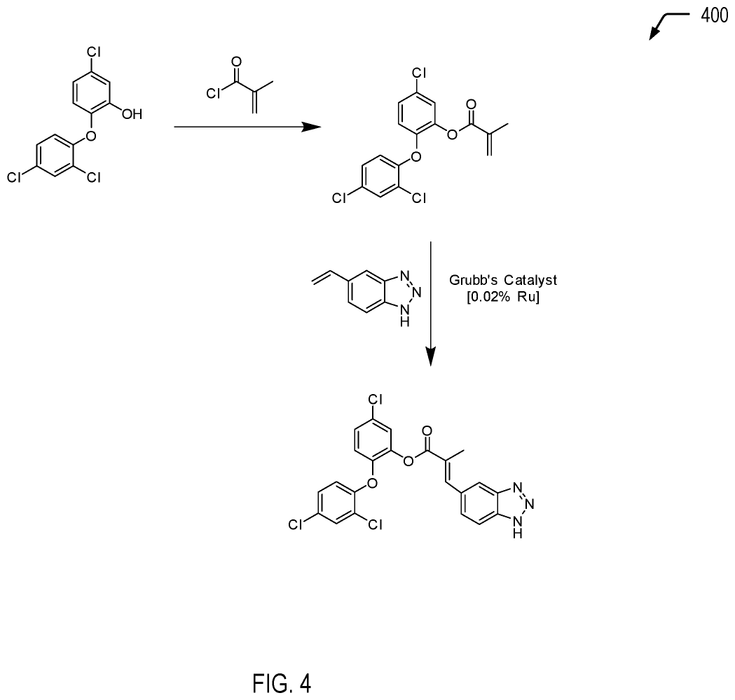

As described further herein, a triazole-based corrosion inhibitor small molecule that is functionalized with a reactive functional group (such as one of the reactive functional groups depicted in FIG. 2) may be reacted either directly with a biocide containing a compatibly reactive functional group (see e.g. FIG. 3) or with a small molecule, oligomer, or polymer “linker” with a compatibly reactive functional group (see e.g. FIGS. 4-6). The “linker” may already be functionalized with a biocidal molecule or may be functionalized with a biocidal molecule in a subsequent step. The corrosion inhibitor and/or biocide may be added as terminal end-groups or as co-monomers and contained within the main chain of the “linker.”

FIG. 3 is a chemical reaction diagram 300 illustrating an example of a process of forming a biocidal-functionalized corrosion inhibiting small molecule having a direct linkage between a biocidal group and a corrosion inhibitor group, according to one embodiment. The direct linkage may be formed by chemically reacting a biocidal compound having a first reactive functional group with a functionalized triazole compound having a second reactive functional group.

The left side of the chemical reaction diagram 300 depicts an illustrative, non-limiting example of a biocidal compound that includes a first reactive functional group. The biocidal compound of FIG. 3 is Triclosan (2,4,4′-Trichloro-2′-hydroxydiphenyl ether), with the first reactive functional group corresponding to a hydroxyl group. The chemical reaction diagram 300 depicts, over the reaction arrow, an illustrative, non-limiting example of a functionalized triazole compound that includes a second reactive functional group and a corrosion inhibitor group that includes a triazole ring for copper (Cu) corrosion inhibition. The functionalized triazole compound of FIG. 3 is benzotriazole-5-carbonyl chloride, with the second reactive functional group corresponding to a chloride group.

The right side of the chemical reaction diagram 300 illustrates that the chemical reaction between the first reactive functional group (the OH group) and the second reactive functional group (the chloride group) forms a biocidal-functionalized corrosion inhibiting small molecule having the following structure:

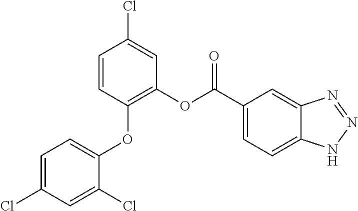 [SMILES: O=C(Oc1cc(Cl)ccc1Oc1ccc(Cl)cc1Cl)c1ccc2[nH]nnc2c1]

In the particular embodiment depicted in FIG. 3, the direct linkage between the biocidal group and the corrosion inhibitor group corresponds to an ester linkage. The ester linkage is degradable to release the biocidal compound (e.g., Triclosan in FIG. 3) from the biocidal-functionalized corrosion inhibiting small molecule, resulting in the formation of a carboxylic acid having the following structure:

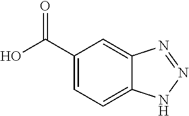 [SMILES: O=C(O)c1ccc2[nH]nnc2c1]

In other embodiments, the biocidal compound and/or the functionalized triazole compound may include alternative functional groups that react to form a “non-degradable” direct linkage. This may be advantageous in some instances, such as to enable biocidal activity to occur at critical locations where the corrosion inhibitor group binds to copper-based hardware.

As an example, the biocidal compound may correspond to an “antimicrobial monomer” having an antimicrobial functional group that is distinct from the first reactive functional group. To illustrate, the biocidal compound may correspond to an antimicrobial monomer having the following structure:

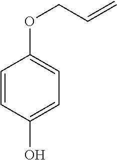

In this example, the active agent is the phenol group. Selection of an alternative functionalized triazole compound having an appropriate reactive functional group may enable the formation of a “non-degradable” linkage. As such, the biocidal compound may represent an example of a biocidal compound that includes an antimicrobial functional group (the phenol group) that is distinct from the first reactive functional group (the vinylic group). Other examples of antimicrobial functional groups that are distinct from the reactive functional group include: an organotin group; an imidazole derivative group; a Norfloxacin group; and an 8-Hydroxyquinoline group.

Thus, FIG. 3 depicts an example of a process of forming a biocidal-functionalized corrosion inhibiting small molecule. In FIG. 3, the biocidal-functionalized corrosion inhibiting small molecule has a direct linkage between a biocidal group and a corrosion inhibitor group. One advantage that may be associated with such a direct linkage is that it allows biocidal activity to occur at critical locations where the corrosion inhibitor group attaches to copper-based hardware (e.g., in a recirculating cooling water system).

FIG. 4 is a chemical reaction diagram 400 illustrating an example a process of forming a biocidal-functionalized corrosion inhibiting small molecule having a linking group between a biocidal group and a corrosion inhibitor group, according to one embodiment.

The left side of the chemical reaction diagram 400 depicts an illustrative, non-limiting example of a biocidal compound. The biocidal compound of FIG. 4 is Triclosan (2,4,4′-Trichloro-2′-hydroxydiphenyl ether). The chemical reaction diagram 400 depicts, over the reaction arrow, an illustrative, non-limiting example where acryloyl chloride is chemically reacted with the hydroxyl group of the biocidal compound. The right side of the chemical reaction diagram 400 illustrates that the chemical reaction results in formation of a methacrylate group.

FIG. 4 illustrates an alternative example of a functionalized triazole compound including a second reactive functional group and a corrosion inhibitor group that includes a triazole ring for copper (Cu) corrosion inhibition. The functionalized triazole compound of FIG. 4 is a 5-substituted BtaH compound, with the second reactive functional group corresponding to a vinyl functional group. The chemical reaction may utilize a Grubb's catalyst [0.02% Ru].

The 5-substituted BtaH compound depicted in FIG. 4 may be synthesized according to the following procedure. 5-bromobenzothiazole (1.0 equiv.), vinyl boronic acid pinacol ester (1.2 equiv.) and tetrakis(triphenylphosphine)palladium(0) (Pd(PPh₃)₄, 5 mol %)) is dissolved in dry toluene (25 mL) under nitrogen. A deaerated K₂CO₃ solution (2M in 1:2 of water/ethanol) and a few drops of Aliquat 336 are added under nitrogen. The reaction mixture is refluxed for about 24 hours, and the reaction is monitored for completion by thin layer chromatography. The organic phase is filtered through a plug of Celite®. Standard procedures for solvent removal and purification are then performed to produce the 5-substituted BtaH compound.

The bottom of the chemical reaction diagram 400 illustrates that the chemical reaction of the methacrylate-functionalized biocidal compound and the 5-substituted triazole compound (having the vinyl functional group) forms a biocidal-functionalized corrosion inhibiting small molecule with a degradable ester linkage having the following structure:

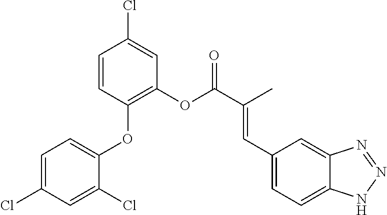 [SMILES: C/C(=C\c1ccc2[nH]nnc2c1)C(=O)Oc1cc(Cl)ccc1Oc1ccc(Cl)cc1Cl]

The ester linkage is degradable to release the biocidal compound (e.g., Triclosan in FIG. 4) from the biocidal-functionalized corrosion inhibiting small molecule, resulting in the formation of a carboxylic acid having the following structure:

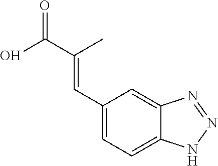

Thus, FIG. 4 depicts an example of a process of forming a biocidal-functionalized corrosion inhibiting small molecule. In FIG. 4, the biocidal-functionalized corrosion inhibiting small molecule has a degradable linking group between a biocidal group and a corrosion inhibitor group. One advantage that may be associated with such a direct linkage is that it allows for the corrosion inhibitor group to attach to the point where corrosion inhibition is required while allowing the biocide to detach itself and react at a given time with free floating bacteria.

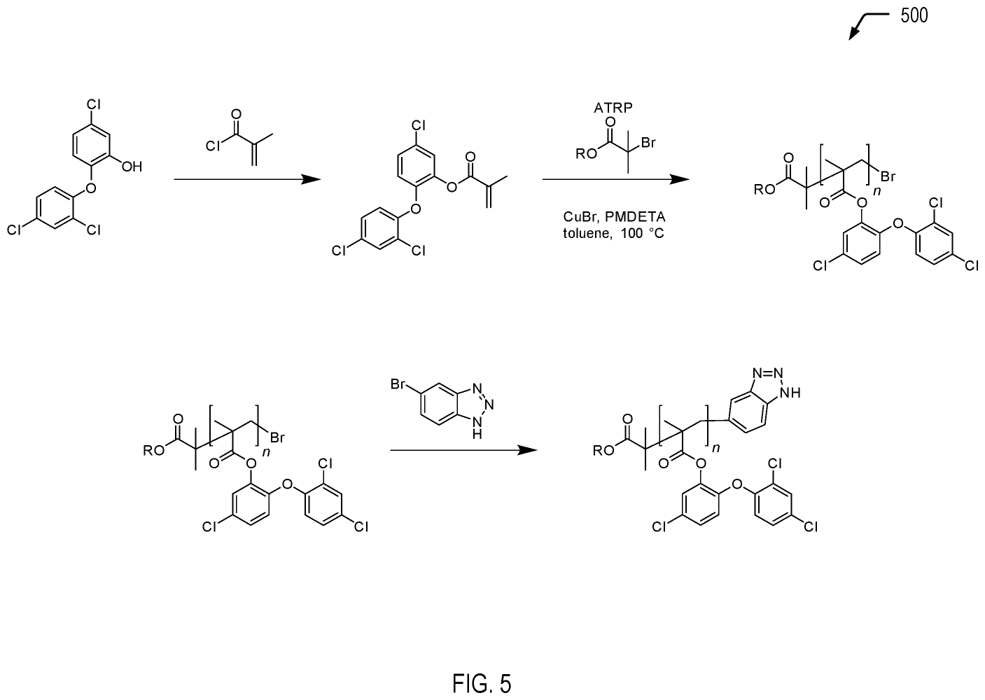

FIG. 5 is a chemical reaction diagram 500 illustrating an example a process of forming a biocidal-functionalized corrosion inhibiting polymeric (or oligomeric) material in which a corrosion inhibitor group forms a terminal end-group, according to one embodiment. While FIG. 5 depicts an illustrative, non-limiting example in which a methacrylate-functionalized Triclosan compound is utilized as the monomer, it will be appreciated that a variety of other functionalized biocidal compounds may be utilized.

The first chemical reaction depicted in the chemical reaction diagram 500 of FIG. 5 corresponds to the first chemical reaction depicted in the chemical reaction diagram 400 of FIG. 4, resulting in the formation of the methacrylate-functionalized biocidal compound. In contrast to FIG. 4, where the methacrylate-functionalized biocidal compound is utilized to form a biocidal-functionalized corrosion inhibiting small molecule, FIG. 5 illustrates the utilization of the methacrylate-functionalized biocidal compound as an antimicrobial monomer to form an oligomeric/polymeric material.

The second chemical reaction depicted in the chemical reaction diagram 500 of FIG. 5 corresponds to an example of a polymerization reaction (e.g., a radical polymerization reaction) in which a monomer mixture that includes an antimicrobial monomer having a first reactive functional group (the methacrylate functional group) is utilized to form a first oligomeric/polymeric material. The first oligomeric/polymeric material has a terminal reactive functional group (e.g., a bromide group). The reaction corresponds to an Atom Transfer Radical Polymerization (ATRP), where the bromodimethyl ester over the reaction arrow is the initiator, the CuBr is the catalyst, and the PMDETA becomes a ligand on the copper catalyst. Typical reaction conditions include toluene as the solvent, with the reaction proceeding at a temperature of about 100° C.

In FIG. 5, the integer n corresponds to a number of repeat units that contain a biocide group. Reaction conditions may be controlled to form an oligomeric material (where n is in a range of about 10 to 100) or a polymeric material (where n is greater than 100). One of ordinary skill in the art will appreciate the number of repeat units may vary depending on the particular biocidal compound that is selected, the environmental conditions (e.g., pH/temperature of cooling water), the particular copper-based hardware, or a combination thereof, among other possible factors.

In the bottom portion of the chemical reaction diagram 500 of FIG. 5, the terminal reactive functional group of the first oligomeric/polymeric material is chemically reacted with another example of a substituted triazole compound. In the example of FIG. 5, the substituted triazole compound is 5-bromo-benzotriazole, where the bromide group represents a second reactive functional group (that is different from the methacrylate group). The chemical reaction results in the formation of a biocidal-functionalized corrosion inhibiting polymeric material, with the corrosion inhibitor group of the substituted triazole compound (e.g., the BtaH group in the example of FIG. 5) forming a terminal end-group.

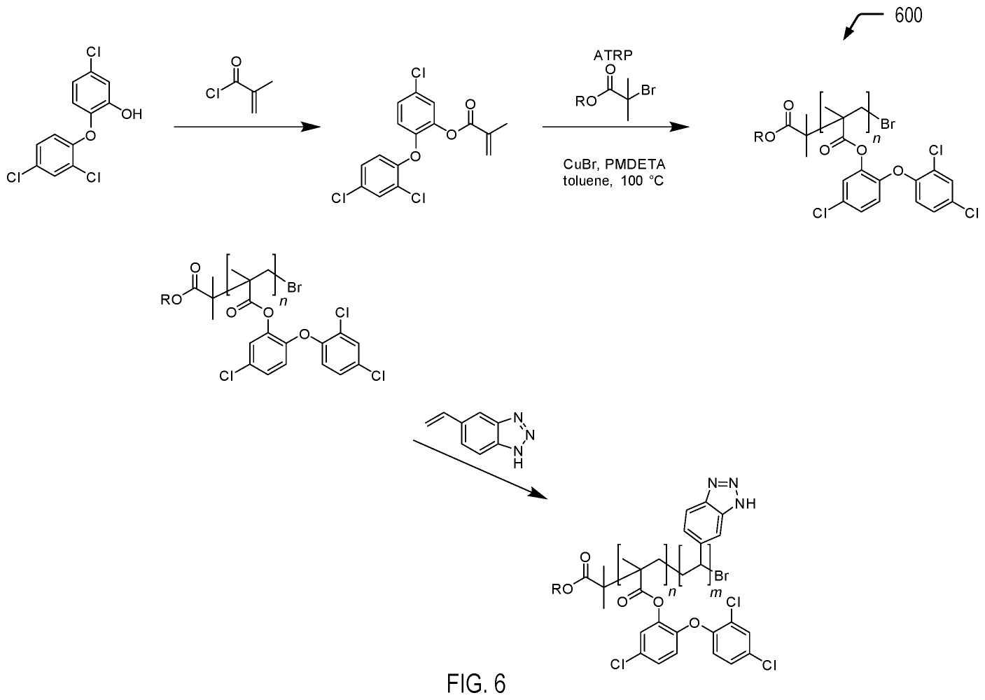

Thus, FIG. 5 depicts an example of a process of forming a biocidal-functionalized corrosion inhibiting polymeric material. The biocidal-functionalized corrosion inhibiting polymeric material has a repeat unit with a degradable linking group (e.g., a hydrolysable ester linkage) that binds the biocidal group to a polymeric backbone. In FIG. 5, a corrosion inhibitor group forms a terminal end-group of the biocidal-functionalized corrosion inhibiting polymeric material. By contrast, FIG. 6 depicts an example of a block co-polymer that includes a second repeat unit having a corrosion inhibiting group bound to a polymeric backbone.

FIG. 6 is a chemical reaction diagram 600 illustrating an example a process of forming a biocidal-functionalized corrosion inhibiting block co-polymer having a first block that includes a biocidal group and a second block that includes a corrosion inhibitor group, according to one embodiment. While FIG. 6 depicts an illustrative, non-limiting example in which a methacrylate-functionalized Triclosan compound is utilized as the monomer, it will be appreciated that a variety of other functionalized biocidal compounds may be utilized.

The chemical reactions depicted at the top of the chemical reaction diagram 600 of FIG. 6 correspond to the chemical reactions depicted at the top of the chemical reaction diagram 500 of FIG. 5, resulting in the formation of the first oligomeric/polymeric material having the terminal reactive functional group (e.g., the bromide group). In FIG. 6, the repeat unit of the first oligomeric/polymeric material corresponds to a first block of a block co-polymer, with the integer n corresponding to a number of repeat units in the first block that contain the biocide group.

The chemical reaction depicted at the bottom of the chemical reaction diagram 600 of FIG. 6 illustrates that, after forming the first block of the block co-polymer from the monomer mixture, a substituted triazole compound may be added to the monomer mixture to form a second block of the block co-polymer. The substituted triazole compound of FIG. 6 corresponds to the 5-substituted BtaH compound of FIG. 4, having a vinyl reactive functional group. Radical polymerization results in formation of the second block having multiple corrosion inhibitor groups bound to the polymer backbone.

In FIG. 6, the integer m corresponds to a number of repeat units in the second block that contain the corrosion inhibitor group. Reaction conditions may be controlled to form an oligomeric material (where m is in a range of about 10 to 100) or a polymeric material (where m is greater than 100). One of ordinary skill in the art will appreciate that the number of repeat units may vary depending on the particular biocidal compound that is selected, the environmental conditions (e.g., pH/temperature of cooling water), the particular copper-based hardware, or a combination thereof, among other possible factors.

Thus, FIG. 6 depicts an example of a process of forming a biocidal-functionalized corrosion inhibiting polymeric material, corresponding to a block co-polymer. The biocidal-functionalized corrosion inhibiting polymeric material has a first block with a degradable linking group (e.g., a hydrolysable ester linkage) that binds the biocidal group to a polymeric backbone. In contrast to FIG. 5 where a single corrosion inhibiting group forms a terminal end-group, FIG. 6 illustrates that a second block of the block co-polymer includes multiple corrosion inhibiting groups bound to the polymeric backbone. The ability to control the relative number of biocidal repeat units and corrosion inhibiting repeat units may provide advantages in some instances. For example, additional triazole moieties may provide advantages in the formation of a Cu-Bta complex at a copper surface.

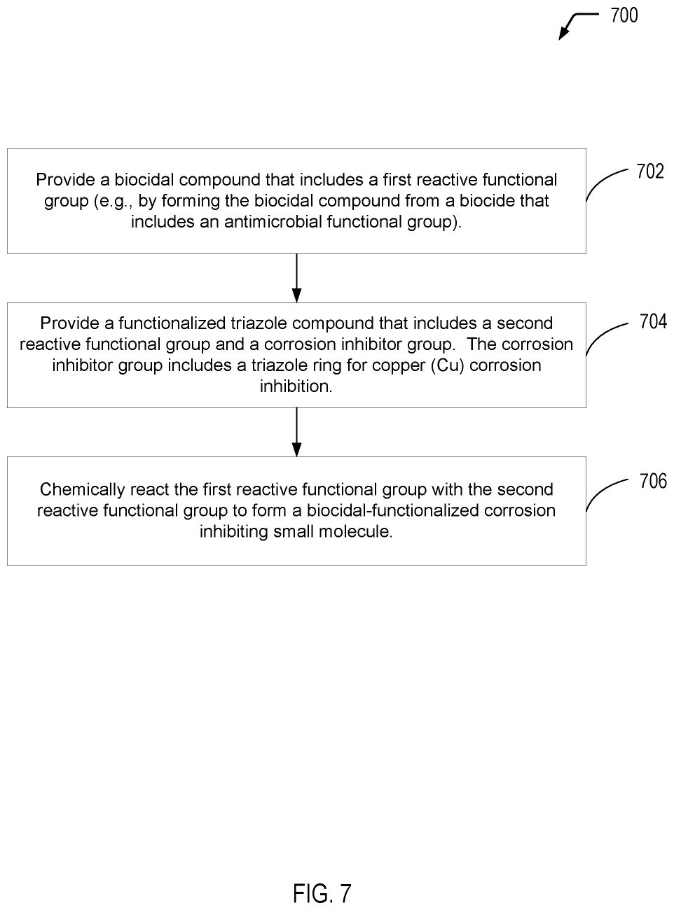

Referring to FIG. 7, a flow diagram illustrates a particular embodiment of a process 700 of forming a biocidal-functionalized corrosion inhibiting small molecule.

The process 700 includes providing a biocidal compound that includes a first reactive functional group, at 702. As an example, referring to FIG. 3, a reactive functional group of the biocidal molecule corresponds to a hydroxyl group. In some embodiments, the first reactive functional group may be formed from a biocide that includes an antimicrobial functional group. For example, referring to FIG. 4, the hydroxyl group of the biocidal molecule of FIG. 3 may be converted to a methacrylate group.

The process 700 includes providing a functionalized triazole compound that includes a second reactive functional group and a corrosion inhibitor group, at 704. The corrosion inhibitor group includes a triazole ring for copper (Cu) corrosion inhibition. For example, referring to FIG. 3, the functionalized triazole compound corresponds to a 5-substituted BtaH compound (e.g., Benzotriazole-5-carbonyl chloride). As another example, referring to FIG. 4, the functionalized triazole compound corresponds to a 5-substituted BtaH compound having a vinylic functional group.

The process 700 includes chemically reacting the first reactive functional group with the second reactive functional group to form a biocidal-functionalized corrosion inhibiting small molecule, at 706. As an example, referring to FIG. 3, the reaction of the hydroxyl group with the chlorocarbonyl group forms a biocidal-functionalized corrosion inhibiting small molecule having a biocide directly linked to a triazole. As another example, referring to FIG. 4, the reaction of the methacrylate group and the vinylic groups forms a biocidal-functionalized corrosion inhibiting small molecule having a linking group between a biocide and a triazole.

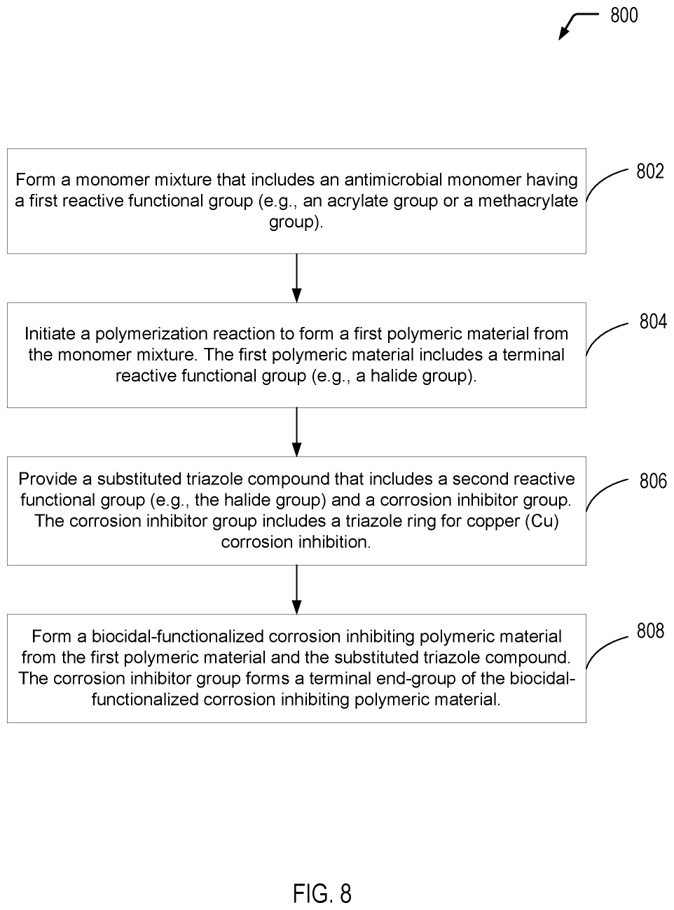

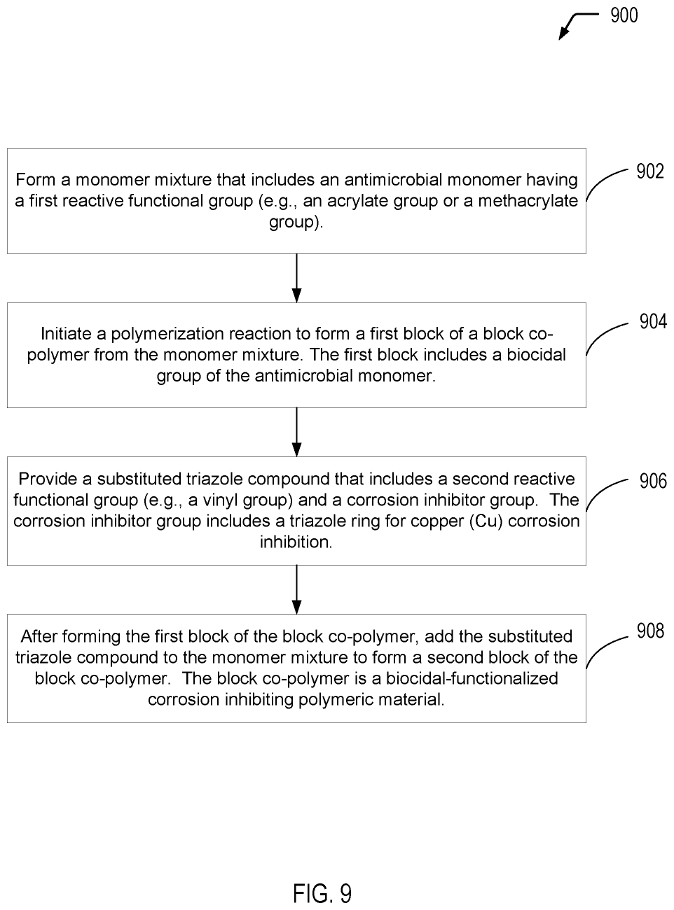

Thus, FIG. 7 is a first example of a process of forming a biocidal-functionalized corrosion inhibitor. In the example of FIG. 7, the biocidal-functionalized corrosion inhibitor corresponds to a biocidal-functionalized corrosion inhibiting small molecule. In some cases, the biocidal-functionalized corrosion inhibiting small molecule may have a direct linkage between a biocidal group and a corrosion inhibitor group (see e.g. FIG. 3). In other cases, the biocidal-functionalized corrosion inhibiting small molecule may have a linking group between the biocidal group and the corrosion inhibitor group (see e.g. FIG. 4). By contrast, FIGS. 8 and 9 illustrate examples of processes of forming biocidal-functionalized corrosion inhibiting polymeric materials.

Referring to FIG. 8, a flow diagram illustrates a particular embodiment of a process 800 of forming a biocidal-functionalized corrosion inhibiting polymeric material. In the particular embodiment of FIG. 8, a corrosion inhibitor group forms a terminal end-group of the biocidal-functionalized corrosion inhibiting polymeric material.

The process 800 includes forming a monomer mixture that includes a biocidal monomer having a first reactive functional group, at 802. In some cases, the first reactive functional group may include an acrylate group or a methacrylate group. For example, the biocidal monomer of FIG. 5 includes a methacrylate group.

The process 800 includes initiating a polymerization reaction to form a first polymeric material from the monomer mixture, at 804. The first polymeric material includes a terminal reactive functional group (e.g., a halide group, such as a bromide group). For example, referring to FIG. 5, the first polymeric material includes a terminal bromide group.

The process 800 includes providing a substituted triazole compound that includes a second reactive functional group (e.g., the bromide group) and a corrosion inhibitor group, at 806. The corrosion inhibitor group includes a triazole ring for copper (Cu) corrosion inhibition. For example, referring to FIG. 5, the substituted triazole compound includes a 5-substituted BtaH compound having a bromide functional group.

The process 800 includes forming a biocidal-functionalized corrosion inhibiting polymeric material from the first polymeric material and the substituted triazole compound, at 808. The corrosion inhibitor group forms a terminal end-group of the biocidal-functionalized corrosion inhibiting polymeric material. For example, referring to FIG. 5, the corrosion inhibitor group (the BtaH group) forms the terminal end-group of the biocidal-functionalized corrosion inhibiting polymeric material.

Thus, FIG. 8 is a first example of a process of forming a biocidal-functionalized corrosion inhibiting polymeric material. In FIG. 8, polymerization results in formation of a polymeric material having a repeat unit having a side chain that includes a biocidal group. The polymeric material includes a terminal reactive functional group (e.g., a bromide group), and the substituted triazole (e.g., 5-bromo-benzotriazole) reacts with the terminal reactive functional group such that the corrosion inhibitor group (e.g., a BtaH moiety) forms a terminal end-group. By contrast, FIG. 9 illustrates an alternative example of a block co-polymer having a second block that includes the corrosion inhibitor group (e.g., the BtaH moiety).

Referring to FIG. 9, a flow diagram illustrates a particular embodiment of a process 900 of forming a biocidal-functionalized corrosion inhibiting polymeric material. In the particular embodiment of FIG. 9, the biocidal-functionalized corrosion inhibiting polymeric material corresponds to a block co-polymer having a first block that includes a biocidal group and a second block that includes a corrosion inhibitor group.

The process 900 includes forming a monomer mixture that includes an antimicrobial monomer having a first reactive functional group, at 902. For example, the first reactive functional group may include an acrylate group or a methacrylate group. For example, the biocidal monomer of FIG. 6 includes a methacrylate group.

The process 900 includes initiating a polymerization reaction to form a first block of a block co-polymer from the monomer mixture, at 904. The first block includes a biocidal group of the antimicrobial monomer. For example, referring to FIG. 6, the first block of the co-polymer includes the biocide group.

The process 900 includes providing a substituted triazole compound that includes a second reactive functional group (e.g., a vinyl group) and a corrosion inhibitor group, at 906. The corrosion inhibitor group includes a triazole ring for copper (Cu) corrosion inhibition. For example, referring to FIG. 6, substituted triazole compound corresponds to a 5-substituted BtaH compound having a vinyl functional group.

After forming the first block of the block co-polymer, the process 900 includes adding the substituted triazole compound to the monomer mixture to form a second block of the block co-polymer, at 908. The block co-polymer is a polymeric biocidal-functionalized corrosion inhibiting polymeric material. For example, referring to FIG. 6, the second block of the co-polymer includes the corrosion inhibitor group.

Thus, FIG. 9 is a second example of a process of forming a biocidal-functionalized corrosion inhibiting polymeric material, corresponding to a block co-polymer. In FIG. 9, polymerization of the antimicrobial monomer results in formation of a first block of the block co-polymer. After forming the first block, a substituted triazole containing a suitable reactive functional group (e.g., a vinylic group) is used to form a second block of the block co-polymer. The ability to control the relative number of biocidal repeat units and corrosion inhibiting repeat units (corresponding to the integers n and m in the representative example of FIG. 6), may provide advantages in some instances. For example, additional triazole moieties may provide advantages in the formation of a Cu-Bta complex at a copper surface.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A biocidal-functionalized corrosion inhibitor that includes a biocidal group linked to a corrosion inhibitor group, the corrosion inhibitor group including a triazole ring for copper (Cu) corrosion inhibition.

2. The biocidal-functionalized corrosion inhibitor of claim 1, wherein the corrosion inhibitor group includes a 1H-1,2,3-Triazole or a 1H-1,2,3-Triazole derivative.

3. The biocidal-functionalized corrosion inhibitor of claim 2, wherein the 1H-1,2,3-Triazole derivative includes a 1H-1,2,3-Benzotriazole (BtaH).

4. The biocidal-functionalized corrosion inhibitor of claim 1, wherein the biocidal group is linked to the corrosion inhibitor group via a linking group that is degradable to release a biocidal compound from the biocidal-functionalized corrosion inhibitor.

5. The biocidal-functionalized corrosion inhibitor of claim 4, wherein the linking group includes a hydrolysable ester linkage.

6. The biocidal-functionalized corrosion inhibitor of claim 4, wherein the biocidal compound includes an antimicrobial functional group selected from the group consisting of: a hydroxyl group, a carboxyl group, and an amino group.

7. A process of forming a biocidal-functionalized corrosion inhibiting small molecule, the process comprising:
providing a biocidal compound that includes a first reactive functional group;
providing a functionalized triazole compound that includes a second reactive functional group and a corrosion inhibitor group, the corrosion inhibitor group including a triazole ring for copper (Cu) corrosion inhibition; and
chemically reacting the first reactive functional group with the second reactive functional group to form a biocidal-functionalized corrosion inhibiting small molecule.

8. The process of claim 7, wherein the chemical reaction of the first reactive functional group with the second reactive functional group forms a linking group that is degradable to release the biocidal compound from the biocidal-functionalized corrosion inhibitor.

9. The process of claim 8, wherein the linking group includes a hydrolysable ester linkage.

10. The process of claim 7, wherein the functionalized triazole compound includes a 5-substituted 1H-1,2,3-Benzotriazole (BtaH) compound.

11. The process of claim 10, wherein the 5-substituted BtaH compound is selected from the group consisting of: benzotriazole-5-carbonyl chloride; 5-bromo-benzotriazole; 5-chlorobenzotriazole; 5-amino-1H-benzotriazole; and benzotriazole-5-carboxylic acid.

12. The process of claim 7, wherein the functionalized triazole compound includes a 4-substituted 1H-1,2,3-Benzotriazole (BtaH) compound.

13. The process of claim 12, wherein the 4-substituted BtaH compound is selected from the group consisting of: 4-chlorobenzotriazole; 4-hydroxybenzotriazole; and benzotriazole-4-carboxylic acid.

14. The process of claim 7, wherein the biocidal compound includes an antimicrobial functional group that is distinct from the first reactive functional group, the antimicrobial functional group selected from the group consisting of: an organotin group; an imidazole derivative group; a Norfloxacin group; a phenol group; and an 8-Hydroxyquinoline group.

15. The process of claim 7, wherein the biocidal compound is Triclosan (2,4,4′-Trichloro-2′-hydroxydiphenyl ether), and wherein the first reactive functional group is a hydroxyl group.

16. A process of forming a biocidal-functionalized corrosion inhibiting polymeric material, the process comprising:
forming a monomer mixture that includes an antimicrobial monomer having a first reactive functional group;
initiating a polymerization reaction to form a first polymeric material from the monomer mixture;
providing a substituted triazole compound that includes a second reactive functional group and a corrosion inhibitor group, the corrosion inhibitor group including a triazole ring for copper (Cu) corrosion inhibition; and
forming a biocidal-functionalized corrosion inhibiting polymeric material from the first polymeric material and the substituted triazole compound.

17. The process of claim 16, wherein:
the corrosion inhibitor group forms a terminal end-group of the biocidal-functionalized corrosion inhibiting polymeric material; and
forming the biocidal-functionalized corrosion inhibiting polymeric material from the first polymeric material and the substituted triazole compound includes chemically reacting a terminal reactive functional group of the first polymeric material with the second reactive functional group of the substituted triazole compound.

18. The process of claim 16, wherein:
the biocidal-functionalized corrosion inhibiting polymeric material is a block co-polymer having a first block that includes a biocidal group of the antimicrobial monomer and a second block that includes the corrosion inhibitor group; and
forming the biocidal-functionalized corrosion inhibiting polymeric material includes, after forming the first block of the block co-polymer, adding the substituted triazole compound to the monomer mixture to form the second block of the block co-polymer.

19. The process of claim 16, wherein the first reactive functional group of the antimicrobial monomer includes an acrylate group or a methacrylate group.

20. The process of claim 16, wherein the second reactive functional group of the substituted triazole compound includes a halide group or a vinyl group.
